(19) United States
(12) Patent Application Publication
(10) Pub. No.: US 2013/0066950 A1
(43) Pub. Date: Mar. 14, 2013

(54) Service Development Platform, System and Method Thereof

(71) Applicants: Kai Liao, Shenzhen (CN); Dong Wang, Shenzhen (CN); Xi Zuo, Shenzhen (CN)

(72) Inventors: Kai Liao, Shenzhen (CN); Dong Wang, Shenzhen (CN); Xi Zuo, Shenzhen (CN)

(73) Assignee: ZTE CORPORATION, Shenzhen City, Guangdong Province (CN)

(21) Appl. No.: 13/501,296

(22) PCT Filed: Feb. 18, 2011
(86) PCT No.: PCT/CN2011/071088

§ 371 Date: Apr. 11, 2012

(30) Foreign Application Priority Data
Jun. 1, 2010 (CN) 201010191651.5

(51) Int. Cl. G06F 15/16

(52) U.S. Cl. 709/203

(57) ABSTRACT

The present invention discloses a service development platform, system and method, wherein a service development platform processes a service request of a user equipment (UE), and the method includes: the UE dialing service access codes and initiating the service request; the service development platform establishing a media channel with the UE; the service development platform loading a WEB page on a WEB browser according to the service request of the UE; the service development platform capturing data of the WEB page on the WEB browser and sending the data after encapsulation to the UE through the media channel; and the service development platform receiving key information of the UE through the media channel, and sending the key information of the UE to the WEB browser in manner of a windows message, so as to realize an operation on the WEB page.

### TECHNICAL FIELD

The present invention relates to a service development platform, system and method, and particularly, to the implementation of video service development and flow control in the mobile communication and broadband communication.

### BACKGROUND OF THE RELATED ART

In the conventional service mode, service logic is controlled mainly by an application server, and the play of audio or video resources is completed by a media server.

When a terminal user dials service access codes, the application server sends a media play request to the media server and plays a preset audio or video file for the user; the user triggers a key operation according to the received audio or video prompt; when the media server receives the key information of the user, it reports the key information of the user to the application server; and the application server selects the corresponding audio or video file according to the key information of the user and the preset service control logic, and sends the media play request to the media server again.

Therefore, in the process of executing the conventional service, the application server and the media server will generate a large amount of signaling interaction. Furthermore, in the process of development of the conventional service, it is required to make a large number of audio or video files and customize complicated service control logic, which is disadvantageous for the rapid development and deployment of new services. The conventional service development mode is to be further improved and developed.

### CONTENT OF THE INVENTION

The technical problem to be solved by the present invention is to provide a service development platform, system and method, so as to simplify the development and extension of services, make it convenient for the operators or service providers to complete the deployment of new services more effectively and more rapidly, improve the development efficiency for making video material, and solve the film source resource problem in the video service.

In order to solve the above technical problem, the present invention proposes a service development method, comprising: a service development platform processing a service request of a user equipment (UE),

the UE dialing service access codes, and initiating the service request;

the service development platform establishing a media channel with the UE;

the service development platform loading a WEB page on a WEB browser according to the service request of the UE;

the service development platform capturing data of the WEB page on the WEB browser and sending the captured data of the WEB page after encapsulation to the UE through the media channel; and

the service development platform receiving key information of the UE through the media channel, and sending the key information of the UE to the WEB browser in manner of a windows message, so as to realize an operation on the WEB page.

Preferably, a plurality of WEB browsers run on the service development platform;

the method further comprises: the service development platform allocating a media resource to the UE which initiates the service request, wherein the step of allocating comprises allocating an idle WEB browser to the UE;

the service development platform establishes the media channel with the UE according to the media resource allocated to the UE;

the service development platform loads the WEB page on the WEB browser allocated to the UE;

the service development platform captures the data of the WEB page on the WEB browser allocated to the UE; and

the service development platform sends the key information of the UE to the WEB browser allocated to the UE.

Preferably, when establishing the media channel with the UE, the service development platform further negotiates an audio/video media type and an encoding type; and

the data of the WEB page captured by the service development platform comprises audio/video data; after capturing the data of the WEB page, the service development platform encapsulates the captured data of the WEB page into an RTP package according to the negotiated audio/video media type and encoding type and then sends to the UE through the media channel.

Preferably, an application server receives the service request of the UE through a video gateway, and then initiates a link establishment request toward the service development platform;

the service development platform establishes a link with the application server; and

the service development platform carries out a signaling interaction with the UE through the application server, allocates the media resource to the UE, establishes the media channel with the UE, and negotiates the audio/video media type and the encoding type.

Preferably, after allocating the idle WEB browser to the UE, the service development platform further maintains a corresponding relation between the UE and the WEB browser; and

the application server further judges a service type according to the service request of the UE, and sends a request of loading a WEB page corresponding to a service requested by the UE to the service development platform after establishing the link with the service development platform; and after receiving the request of loading the WEB page corresponding to the service requested by the UE, the service development platform, according to the corresponding relation, loads the WEB page corresponding to the service requested by the UE on the WEB browser allocated to the UE.

Preferably, after receiving a service finish request of the UE sent from the application server, the service development platform, according to the corresponding relation, stops capturing audio/video on the WEB browser allocated to the UE, releases the occupied resource, and deletes the corresponding relation; and/or

after receiving a service pause request of the UE sent from the application server, the service development platform, according to the corresponding relation, stops capturing audio/video on the WEB browser allocated to the UE.

Preferably, the service development platform hitches a system sound play function when running the WEB browser, and the service development platform captures audio data by the system sound play function; and

the service development platform captures video data by carrying out screen copy on a screen area of the WEB page.

Preferably, the service development platform further monitors a running state and a service state of the WEB browser, and when detecting that the running of the WEB browser is abnormal, restarts the WEB browser; and when detecting that the service is overtime, releasing the occupied resource.

Preferably, the service development platform further comprises an audio/video message,

the service development platform records the audio and video data sent from the UE and stores to a local; and the audio and video data are sent to the service development platform by the UE through the media channel.

In order to solve the above technical problem, the present invention also proposes a service development platform, comprising a control module and a WEB browser process module, wherein,

the control module is configured to: establish a media channel with a user equipment (UE) which initiates a service request; and

the WEB browser process module is configured to: load a WEB page on a WEB browser according to the service request of the UE; capture data of the WEB page on the WEB browser, and sends the captured data of the WEB page after encapsulation to the UE through the media channel established by the control module; and receive key information of the UE through the media channel, and send the key information to the UE to the WEB browser in manner of a windows message, so as to realize an operation on the WEB page.

Preferably, the WEB browser process module is further configured to run a plurality of WEB browsers;

the WEB browser process module is configured to: load the WEB page on the WEB browser allocated to the UE, capture the data of the WEB page on the WEB browser allocated to the UE, and send the key information of the UE to the WEB browser allocated to the UE;

the control module is configured to: allocate a media resource to the UE which initiates the service request, comprising allocating an idle state WEB browser;

the control module is configured to: establish the media channel with the UE according to the media resource allocated to the UE.

Preferably, the control module is further configured to: when establishing the media channel with the UE, negotiate an audio/video media type and an encoding type;

the WEB browser process module is further configured to: comprise audio/video data in the data captured on the WEB page; and

the WEB browser process module is configured to: after capturing the data of the WEB page, encapsulate the captured data of the WEB page into an RTP package according to the negotiated audio/video media type and encoding type and then send to the UE through the media channel.

Preferably, the control module is further configured to: after receiving a link establishment request sent from an application server, establish a link with the application server, carry out a signaling interaction with the UE which initiates the service request through the application server, allocate the media resource to the UE, establish the media channel, and negotiate the audio/video media type and the encoding type.

Preferably, the control module is further configured to: when allocating the idle state WEB browser to the UE, maintain a corresponding relation between the UE and the allocated WEB browser;

the control module is configured to: after receiving a request of loading a WEB page corresponding to a service requested by the UE, which is sent from the application server, forward, according to the corresponding relation, the load request to the WEB browser allocated to the UE on the WEB browser process module, so that the WEB browser loads the WEB page corresponding to the service requested by the UE according to the request.

Preferably, the control module is further configured to: after receiving a service finish request of the UE sent from the application server, forward, according to the corresponding relation, the service finish request of the UE to the WEB browser allocated to the UE on the WEB browser process module, and delete the corresponding relation; and the WEB browser process module is further configured to: after receiving the service finish request of the UE, stop capturing audio/video on the WEB browser allocated to the UE, release the occupied resource, and reset the WEB browser allocated to the UE as an idle state; and/or

the control module is further configured to: after receiving a service pause request of the UE sent from the application server, forward, according to the corresponding relation, the service pause request of the UE to the WEB browser allocated to the UE on the WEB browser process module; and the WEB browser process module is further configured to: after receiving the service pause request of the UE, stop capturing audio/video on the WEB browser allocated to the UE.

Preferably, the WEB browser process module is further configured to: when running the WEB browser, hitch a system sound play function; and

the WEB browser process module is configured to: capture audio data by the system sound play function; and capture video data by carrying out screen copy on a screen area of the WEB page.

The control module is further configured to: monitor a running state and a service state of the WEB browser running in the WEB browser process module, and when detecting that the running of the WEB browser is abnormal, restart the WEB browser; and when detecting that the service is overtime, release the occupied resource.

Preferably, the WEB browser process module is further configured to: receive audio and video data sent from the UE through the media channel, record the data and store to a local.

Preferably, the WEB browser process module comprises an audio data capturing unit, an audio data sending unit, an audio data buffering unit, a video data capturing unit, a video data sending unit, a video data buffering unit, and a receiving package processing unit, wherein,

the audio data capturing unit is configured to capture audio data on the WEB page;

the audio data buffering unit is configured to buffer the audio data captured by the audio data capturing unit;

the audio data sending unit is configured to: encapsulate the audio data buffered by the audio data buffering unit after encoding processing into an RTP data package, and then send to the UE through the media channel with the UE;

the video data capturing unit is configured to capture video data on the WEB page;

the video data buffering unit is configured to buffer the video data captured by the video data capturing unit;

the video data sending unit is configured to: encapsulate the video data buffered by the video data buffering unit after encoding processing into an RTP data package, and then send to the UE through the media channel with the UE; and

the receiving package processing unit is configured to: receive an operation information of the UE and send to the WEB browser in manner of a windows message, so as to perform the operation on the WEB page.

Preferably, the receiving package processing unit is further configured to: receive an instruction sent from the control module and send to the WEB browser; wherein, the instruction comprises an instruction of loading a WEB page corresponding to a service requested by the UE, an instruction of a WEB page corresponding to a service pause request of the UE, and an instruction of a WEB page corresponding to a service finish request of the UE.

Preferably, the service development platform further comprises a record unit, which is configured to record audio and video data sent from the UE and store to a local.

In order to solve the above technical problem, the present invention also proposes a service development system, comprising a video gateway, an application server, a WEB server, and a service development platform as claimed in any one of claims 10-21, wherein,

the application server is configured to: receive a service request of a user through the video gateway, judge a service type, establish a link with the service development platform, and send a request of loading a WEB page corresponding to a service requested by the UE to the service development platform;

the service development platform is configured to: carry out a signaling interaction with the UE through the application server, establish a media channel with the UE; interact with the WEB server, load the WEB page on a WEB browser according to the service request of the UE; capture data of the WEB page on the WEB browser, sends the data after encapsulation to the UE through the media channel; receive key information sent from the UE through the media channel, and send the key information of the UE to the WEB browser in manner of a windows message, so as to realize an operation on the WEB page; and

the WEB server is configured to provide the WEB page corresponding to the service requested by the user.

The present invention provides the service development platform, system and method, which artfully converts the conventional service logic controlled by the application server into achieving the service logic control by the jump function of the WEB page, greatly reducing the signaling interaction with the application server, enhancing the service response speed, simplifying the development and extension of the service, being convenient for the operators or service providers to complete the deployment of new services more efficiently and more rapidly.

### BRIEF DESCRIPTION OF DRAWINGS

FIG. 1 is a flow chart of a service development method according to an embodiment of the present invention;

FIG. 2 is a schematic diagram of an internal structure of a service development platform according to an embodiment of the present invention;

FIG. 3 is a schematic diagram of an internal structure of a WEB browser process module according to an embodiment of the present invention;

FIG. 4 is a schematic diagram of a composition of a service development system according to an embodiment of the present invention; and

FIG. 5 is a schematic diagram of a composition of a service development system according to an application example of the present invention.

### PREFERRED EMBODIMENTS OF THE INVENTION

The present invention provides a service development platform, system and method, and the basic concept thereof is that: a service development platform processes a service request of the UE, including: establishing a media channel with the UE; loading a WEB page on a WEB browser according to the service request of the UE; capturing data of the WEB page on the above WEB browser and sending the captured data of the WEB page after encapsulation to the UE through the media channel; and receiving key information of the UE through the media channel, and sending the key information of the UE to the WEB browser in manner of a windows message, so as to realize an operation on the WEB page. By adopting this solution, service development in manner of the WEB page can be artfully realized, which avoids fussily making a large number of video files, making video material is completed by making the web page, and the development efficiency of the video material is enhanced; moreover, various web page types and technologies can be supported, the WEB page and the embedded sound therein can be converted into standard audio/video streams, which significantly solves the film source resource problem in the video service.

Hereinafter, the embodiments of the present invention will be illustrated in detail in combination with the accompanying drawings.

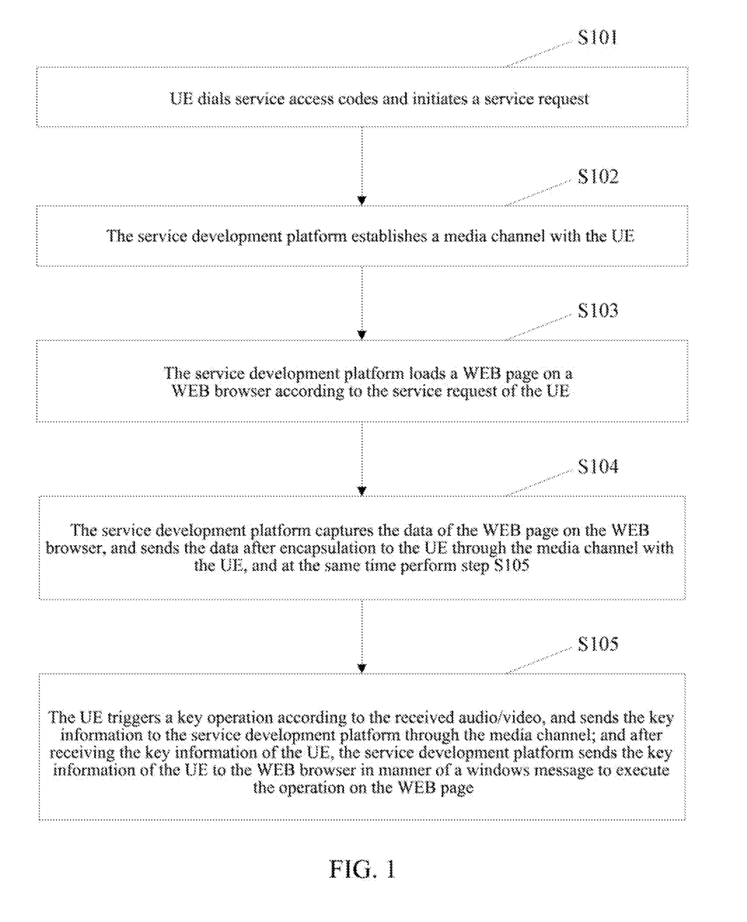

Referring to FIG. 1, it shows a service development method according to an embodiment of the present invention, and the service development can be artfully realized based on WEB by processing a service request of the UE by a service development platform of the present invention, which includes the following steps.

In step S101: the UE dials service access codes and initiates the service request.

In step S102: the service development platform establishes the media channel with the UE.

Preferably, a plurality of WEB browsers can run on the service development platform. Specifically, when the service development platform starts up, a certain number of WEB browser processes can be started up, these WEB browser windows are arranged on a virtual desktop in turn, and information, such as window handle, size, coordinate location, etc., of each process is recorded. Wherein, the virtual desktop needs to be installed with a virtual display card driver.

The service development platform also allocate a media resource to the UE which initiates the service request, including allocating a port number, an IP address, an idle WEB browser, etc., to the UE. The service development platform establishes the media channel with the UE according to the media resource allocated to the UE.

In step 103: the service development platform loads the WEB page on the WEB browser according to the service request of the UE.

Preferably, when a plurality of WEB browsers run on the service development platform, the requests of a plurality of users can be processed in parallel, that is, the service development platform respectively loads a WEB page corresponding to a service requested by the UE on the WEB browser allocated to each UE according to the service request of each UE.

In step S104: the service development platform captures the data of the WEB page on the WEB browser, and sends the data after encapsulation to the UE through the media channel with the UE, and at the same time step S105 is performed.

The data of the WEB page captured by the service development platform includes audio/video data. When the service development platform establishes the media channel with the UE, it also negotiates an audio/video media type and an encoding type; and after capturing the data on the WEB page, the service development platform encapsulates the data into an RTP package according to the negotiated audio/video media type and encoding type and then sends to the UE through the media channel.

The following manner can be adopted to realize that the service development platform captures the data of the WEB page: the service development platform can hitch a system sound play function when running the WEB browser, and capture the audio data through the system sound play function. The service development platform can carry out screen copy on a screen area in which a WEB browser window is located to capture the video data.

In step S105: the UE triggers a key operation according to the received audio/video, and sends the key information to the service development platform through the media channel; and after receiving the key information of the UE, the service development platform sends the key information of the UE to the WEB browser in manner of a windows message, to execute the operation on the WEB page.

The operation of the WEB page can include user information input or triggering the jump of the WEB page.

Preferably, in order to ensure the normal operation of the service, the service development platform can also monitor a running state and a service state of the WEB browser, and when detecting that the running of the WEB browser is abnormal, restarts the WEB browser; and when detecting that the service is overtime, releasing the occupied resource. The service being overtime may be caused by the reason such as the network, etc.

Preferably, the service development platform of the present invention can also provide an audio/video message function, including: the UE can send the audio and video data to the service development platform through the media channel; and the service development platform records the audio and video data sent from the UE and stores the same to a local.

In the embodiment of the present invention, during the practical implementation, the participation of intermediate devices, such as an application server and an audio/video gateway is needed. Specifically, the application server receives the service request of the UE through the video gateway, judges the service type according to the service request of the user, and initiates a link establishment request to the service development platform; and the service development platform establishes a link with the application server. Then, the service development platform carries out a signaling interaction with the UE through the application server, allocates the media resource to the UE, establishes the media channel with the UE, and negotiates the audio/video media type and the encoding type.

Preferably, for the situation that several WEB browsers run on the service development platform and can process the service requests of a plurality of users in parallel, the service development platform, after allocating the idle WEB browser to the UE, also maintains a corresponding relation between the UE and the WEB browser. The application server further judges a service type according to the service request of the UE, and sends a request of loading a WEB page corresponding to a service requested by the UE to the service development platform after establishing the link with the service development platform; and after receiving the request of loading the WEB page corresponding to the service requested by the UE, the service development platform, according to the corresponding relation, loads the WEB page corresponding to the service requested by the UE on the WEB browser allocated to the UE.

Preferably, the application server can also send a service finish request of the UE to the service development platform. After receiving the service finish request of the UE, the service development platform, according to the corresponding relation, stops capturing audio/video on the WEB browser allocated to the UE, releases the occupied resource, and deletes the corresponding relation.

Preferably, the application server can also send a service pause request of the UE to the service development platform; and after receiving the service pause request of the UE, the service development platform, according to the corresponding relation, stops capturing audio/video on the WEB browser allocated to the UE.

In order to realize the above method, an embodiment of the present invention also provides a service development platform, and as shown in FIG. 2, it includes a control module and a WEB browser process module, wherein,

the control module is configured to: establish a media channel with a user equipment (UE) which initiates a service request; and

the WEB browser process module is configured to: load a WEB page on a WEB browser according to the service request of the UE; capture data of the WEB page on the WEB browser, and sends the captured data of the WEB page after encapsulation to the UE through the media channel established by the control module; and receive key information of the UE through the media channel, and send the key information to the UE to the WEB browser in manner of a windows message, so as to realize an operation on the WEB page.

Preferably, several WEB browsers run on the WEB browser process module; the WEB browser process module loads the WEB page on the WEB browser allocated to the UE, captures the data of the WEB page on the WEB browser allocated to the UE, and sends the key information of the UE to the WEB browser allocated to the UE. The control module also allocates a media resource to the UE which initiates the service request, including allocating an idle state WEB browser to the UE; and the control module establishes the media channel with the UE according to the media resource allocated to the UE.

Preferably, the control module also negotiates the audio/video media type and the encoding type when establishing the media channel with the UE. The data captured on the WEB page by the WEB browser process module comprises the audio/video data; after capturing the data of the WEB page, the WEB browser process module encapsulates the data into an RTP package according to the negotiated audio/video media type and encoding type and then sends to the UE through the media channel.

Preferably, the control module, after receiving a link establishment request sent from the application server, establishes a link with the application server, carries out a signaling interaction with the UE which initiates the service request through the application server, allocates the media resource to the UE, establish the media channel, and negotiates the audio/video media type and the encoding type.

Preferably, the control module also maintains a corresponding relation between the UE and the WEB browser allocated to the UE when allocating the idle state WEB browser to the UE. The control module, after receiving a request of loading a WEB page corresponding to a service requested by the UE, which is sent from the application server, forwards, according to the corresponding relation, the request to the WEB browser allocated to the UE on the WEB browser process module, so that the WEB browser loads the WEB page corresponding to the service requested by the UE according to the request.

Preferably, after receiving a service finish request of the UE sent from the application server, the control module forwards, according to the corresponding relation, the same to the WEB browser allocated to the UE on the WEB browser process module, and deletes the corresponding relation; and after receiving the service finish request of the UE, the WEB browser process module stops capturing audio/video on the WEB browser allocated to the UE, releases the occupied resource, and resets the WEB browser allocated to the UE as an idle state; and/or

after receiving a service pause request of the UE sent from the application server, the control module forwards, according to the corresponding relation, the service pause request of the UE to the WEB browser allocated to the UE on the WEB browser process module; and after receiving the service pause request of the UE, the WEB browser process module stops capturing audio/video on the WEB browser allocated to the UE.

Preferably, the WEB browser process module also hitches a system sound play function when running the WEB browser; and the WEB browser process module captures audio data through the system sound play function. The WEB browser process module captures the video data by carrying out screen copy on a screen area of the WEB page.

Preferably, the control module is further configured to: monitor a running state and a service state of the WEB browser running in the WEB browser process module, and when detecting that the running of the WEB browser is abnormal, restart the WEB browser; and when detecting that the service is overtime, release the occupied resource.

Preferably, the WEB browser process module also receives the audio and video data sent from the UE through the media channel, records the same and stores the same to a local.

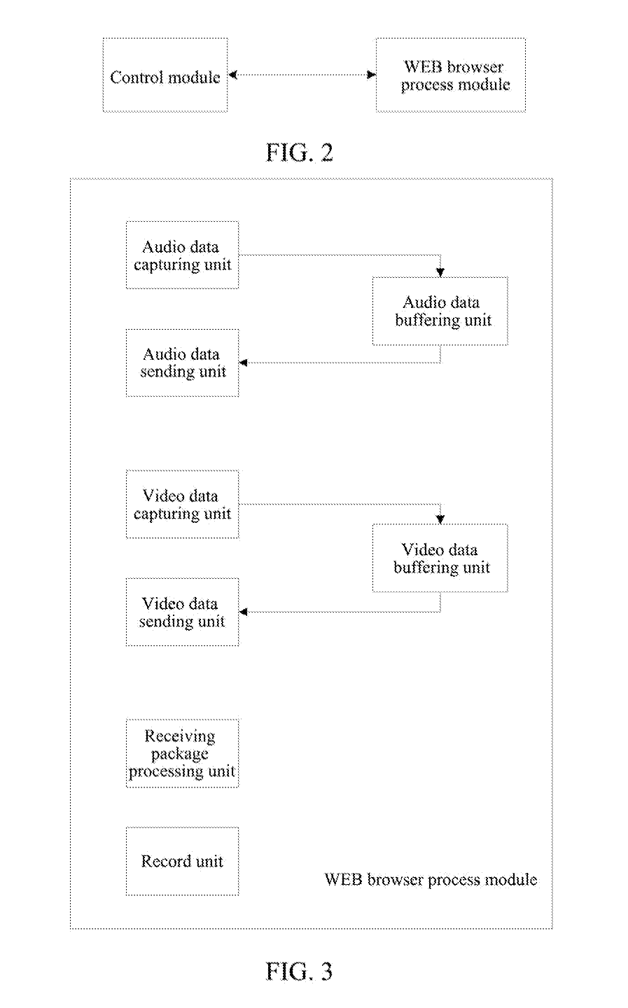

Preferably, referring to FIG. 3, the WEB browser process module can also be divided to include an audio data capturing unit, an audio data sending unit, an audio data buffering unit, a video data capturing unit, a video data sending unit, a video data buffering unit, a receiving package processing unit and a record unit, wherein,

the audio data capturing unit is configured to capture audio data on the WEB page;

the audio data buffering unit is configured to buffer the audio data captured by the audio data capturing unit;

the audio data sending unit is configured to: encapsulate the audio data buffered by the audio data buffering unit after encoding processing into an RTP data package, and then send to the UE through the media channel with the UE;

the video data capturing unit is configured to capture video data on the WEB page;

the video data buffering unit is configured to buffer the video data captured by the video data capturing unit;

the video data sending unit is configured to: encapsulate the video data buffered by the video data buffering unit after encoding processing into an RTP data package, and then send to the UE through the media channel with the UE; and

the receiving package processing unit is configured to: receive an operation information of the UE and send to the WEB browser in manner of a windows message, so as to perform the operation on the WEB page. The receiving package processing unit is further configured to receive an instruction sent from the control module and send the same to the WEB browser, and wherein the instruction comprises an instruction of loading a WEB page corresponding to a service requested by the UE, a service pause request of the UE, and a service finish request of the UE, and so on.

Preferably, when the service development platform provides an audio/video message function, it also includes a record unit, for recording the audio and video data sent from the UE and storing the same to the local.

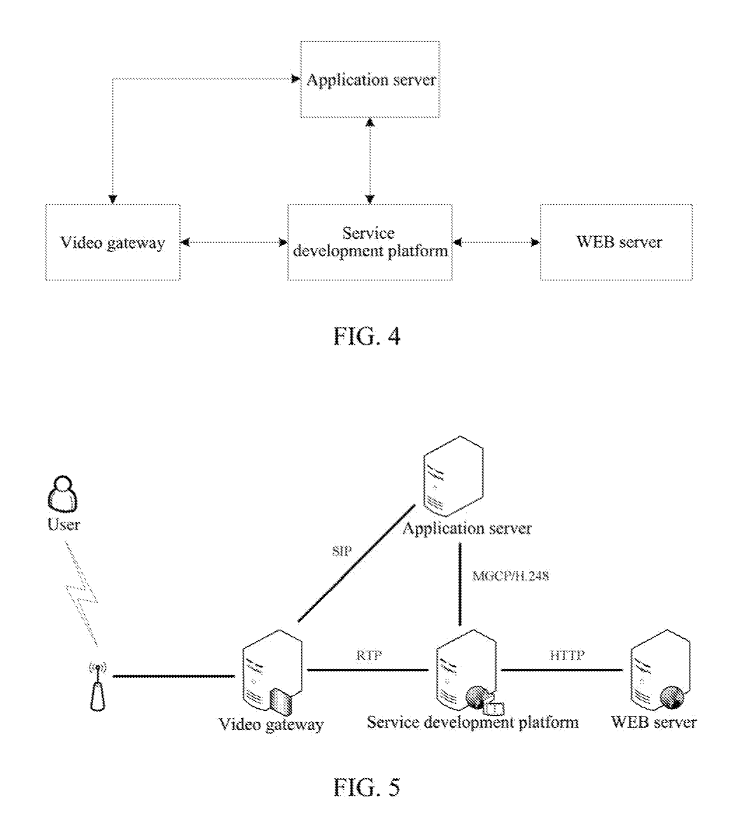

Referring to FIG. 4, it shows a service development system according to an embodiment of the present invention, which at least includes a service development platform with the above functions, a video gateway, an application server and a WEB server, wherein,

the application server is configured to: receive a service request of a user through the video gateway, judge a service type, establish a link with the service development platform, and send a request of loading a WEB page corresponding to a service requested by the UE to the service development platform;

the service development platform is configured to: carry out a signaling interaction with the UE through the application server, establish a media channel with the UE; interact with the WEB server, load the WEB page on a WEB browser according to the service request of the UE; capture data of the WEB page on the WEB browser, sends the data after encapsulation to the UE through the media channel; receive key information sent from the UE through the media channel, and send the key information of the UE to the WEB browser in manner of a windows message, so as to realize an operation on the WEB page; and

the WEB server is configured to provide the WEB page corresponding to the service requested by the user.

Referring to FIG. 5, it shows a specific process of various components of the service development system of an embodiment of the present invention interacting with each other to provide a service to a user: the service development platform communicates with the application server through the media gateway control protocol (MGCP) or H.248 protocol, and accesses the WEB service through the HTTP protocol. When the terminal user dials service access codes, the video gateway receives a request and initiates an SIP calling request to the application server; the application server judges the service type according to the service access codes dialed by the terminal user, and initiates a link establishment request to the service development platform through the MGCP or H.248 protocol; then the service development platform allocates the audio/video media resource to the UE, and negotiates the audio/video encoding type; after the link is established successfully, the application server requests the service development platform to load a predetermined web page according to the service type; when the service development platform loads the web page successfully, it triggers a screen capture and audio capture process, acquires audio/video original data, carries out encoding processing on the original data according to the previously negotiated audio/video encoding type, and encapsulates the same into an RTP package to be sent to the video gateway. The video gateway multiplexes the audio/video data into H.324M streams to be sent to the UE side.

It needs to be illustrated that, the above description regarding to the embodiments of the present invention is relatively detailed and particular, but it is not regarded as a limit to the protection scope of the present patent. It is apparent for those skilled in the art to make various changes to the present invention without departing from the teaching and scope of the present invention. Therefore, the present invention is intended to contain various changes within the scope of the present invention, and the protection scope of the patent should be based on the appended claims.

### INDUSTRIAL APPLICABILITY

The present invention provides the service development platform, system and method, which artfully converts the conventional service logic controlled by the application server into achieving the service logic control by the jump function of the WEB page, greatly reducing the signaling interaction with the application server, enhancing the service response speed, simplifying the development and extension of the service, being convenient for the operators or service providers to complete the deployment of new services more efficiently and more rapidly.

What we claim is:

1. A service development method, comprising: a service development platform processing a service request of a user equipment (UE),
the UE dialing service access codes, and initiating the service request;
the service development platform establishing a media channel with the UE;
the service development platform loading a WEB page on a WEB browser according to the service request of the UE;
the service development platform capturing data of the WEB page on the WEB browser and sending the captured data of the WEB page after encapsulation to the UE through the media channel; and
the service development platform receiving key information of the UE through the media channel, and sending the key information of the UE to the WEB browser in manner of a windows message, so as to realize an operation on the WEB page.

2. The method as claimed in claim 1, wherein,
a plurality of WEB browsers run on the service development platform;
the method further comprises: the service development platform allocating a media resource to the UE which initiates the service request, wherein the step of allocating comprises allocating an idle WEB browser to the UE;
the service development platform establishes the media channel with the UE according to the media resource allocated to the UE;
the service development platform loads the WEB page on the WEB browser allocated to the UE;
the service development platform captures the data of the WEB page on the WEB browser allocated to the UE; and
the service development platform sends the key information of the UE to the WEB browser allocated to the UE.

3. The method as claimed in claim 1, wherein,
when establishing the media channel with the UE, the service development platform further negotiates an audio/video media type and an encoding type; and
the data of the WEB page captured by the service development platform comprises audio/video data; after capturing the data of the WEB page, the service development platform encapsulates the captured data of the WEB page into an RTP package according to the negotiated audio/video media type and encoding type and then sends to the UE through the media channel.

4. The method as claimed in claim 3, further comprising:
an application server receiving the service request of the UE through a video gateway, and then initiating a link establishment request toward the service development platform;
the service development platform establishing a link with the application server; and
the service development platform carrying out a signaling interaction with the UE through the application server, allocating the media resource to the UE, establishing the media channel with the UE, and negotiating the audio/video media type and the encoding type.

5. The method as claimed in claim 4, wherein,
after allocating the idle WEB browser to the UE, the service development platform further maintains a corresponding relation between the UE and the WEB browser; and
the application server further judges a service type according to the service request of the UE, and sends a request of loading a WEB page corresponding to a service requested by the UE to the service development platform after establishing the link with the service development platform; and after receiving the request of loading the WEB page corresponding to the service requested by the UE, the service development platform, according to the corresponding relation, loads the WEB page corresponding to the service requested by the UE on the WEB browser allocated to the UE.

6. (canceled)

7. The method as claimed in claim 1, wherein,
the service development platform hitches a system sound play function when running the WEB browser, and the service development platform captures audio data by the system sound play function; and
the service development platform captures video data by carrying out screen copy on a screen area of the WEB page.

8. The method as claimed in claim 1, wherein,
the service development platform further monitors a running state and a service state of the WEB browser, and when detecting that the running of the WEB browser is abnormal, restarts the WEB browser; and when detecting that the service is overtime, releasing the occupied resource.

9. The method as claimed in claim 1, wherein, the service development platform further comprises an audio/video message,
the service development platform records the audio and video data sent from the UE and stores to a local; and the audio and video data are sent to the service development platform by the UE through the media channel.

10. A service development platform, comprising a control module and a WEB browser process module, wherein,
the control module is configured to: establish a media channel with a user equipment (UE) which initiates a service request; and
the WEB browser process module is configured to: load a WEB page on a WEB browser according to the service request of the UE; capture data of the WEB page on the WEB browser, and sends the captured data of the WEB page after encapsulation to the UE through the media channel established by the control module; and receive key information of the UE through the media channel, and send the key information to the UE to the WEB browser in manner of a windows message, so as to realize an operation on the WEB page.

11. The service development platform as claimed in claim 10, wherein,
the WEB browser process module is further configured to run a plurality of WEB browsers;
the WEB browser process module is configured to: load the WEB page on the WEB browser allocated to the UE, capture the data of the WEB page on the WEB browser allocated to the UE, and send the key information of the UE to the WEB browser allocated to the UE;
the control module is configured to: allocate a media resource to the UE which initiates the service request, comprising allocating an idle state WEB browser;
the control module is configured to: establish the media channel with the UE according to the media resource allocated to the UE.

12. The service development platform as claimed in claim 11, wherein,
the control module is further configured to: when establishing the media channel with the UE, negotiate an audio/video media type and an encoding type;
the WEB browser process module is further configured to: comprise audio/video data in the data captured on the WEB page; and
the WEB browser process module is configured to: after capturing the data of the WEB page, encapsulate the captured data of the WEB page into an RTP package according to the negotiated audio/video media type and encoding type and then send to the UE through the media channel.

13. The service development platform as claimed in claim 12, wherein,
the control module is further configured to: after receiving a link establishment request sent from an application server, establish a link with the application server, carry out a signaling interaction with the UE which initiates the service request through the application server, allocate the media resource to the UE, establish the media channel, and negotiate the audio/video media type and the encoding type.

14. The service development platform as claimed in claim 13, wherein,
the control module is further configured to: when allocating the idle state WEB browser to the UE, maintain a corresponding relation between the UE and the allocated WEB browser;
the control module is configured to: after receiving a request of loading a WEB page corresponding to a service requested by the UE, which is sent from the application server, forward, according to the corresponding relation, the load request to the WEB browser allocated to the UE on the WEB browser process module, so that the WEB browser loads the WEB page corresponding to the service requested by the UE according to the request.

15. (canceled)

16. The service development platform as claimed in claim 10, wherein,
the WEB browser process module is further configured to: when running the WEB browser, hitch a system sound play function; and
the WEB browser process module is configured to: capture audio data by the system sound play function; and capture video data by carrying out screen copy on a screen area of the WEB page.

17. The service development platform as claimed in claim 10, wherein,
the control module is further configured to: monitor a running state and a service state of the WEB browser running in the WEB browser process module, and when detecting that the running of the WEB browser is abnormal, restart the WEB browser; and when detecting that the service is overtime, release the occupied resource.

18. The service development platform as claimed in claim 10, wherein, the WEB browser process module is further configured to: receive audio and video data sent from the UE through the media channel, record the data and store to a local.

19. The service development platform as claimed in claim 10, wherein, the WEB browser process module comprises an audio data capturing unit, an audio data sending unit, an audio data buffering unit, a video data capturing unit, a video data sending unit, a video data buffering unit, and a receiving package processing unit, wherein,
the audio data capturing unit is configured to capture audio data on the WEB page;
the audio data buffering unit is configured to buffer the audio data captured by the audio data capturing unit;
the audio data sending unit is configured to: encapsulate the audio data buffered by the audio data buffering unit after encoding processing into an RTP data package, and then send to the UE through the media channel with the UE;
the video data capturing unit is configured to capture video data on the WEB page;
the video data buffering unit is configured to buffer the video data captured by the video data capturing unit;
the video data sending unit is configured to: encapsulate the video data buffered by the video data buffering unit after encoding processing into an RTP data package, and then send to the UE through the media channel with the UE; and
the receiving package processing unit is configured to: receive an operation information of the UE and send to the WEB browser in manner of a windows message, so as to perform the operation on the WEB page.

20. The service development platform as claimed in claim 19, wherein, the receiving package processing unit is further configured to: receive an instruction sent from the control module and send to the WEB browser; wherein, the instruction comprises an instruction of loading a WEB page corresponding to a service requested by the UE, an instruction of a WEB page corresponding to a service pause request of the UE, and an instruction of a WEB page corresponding to a service finish request of the UE.

21. The service development platform as claimed in claim 19, wherein, the service development platform further comprises a record unit, which is configured to record audio and video data sent from the UE and store to a local.

22. A service development system, comprising a video gateway, an application server, a WEB server, and a service development platform, wherein,
the application server is configured to: receive a service request of a user through the video gateway, judge a service type, establish a link with the service development platform, and send a request of loading a WEB page corresponding to a service requested by the UE to the service development platform;
the service development platform is configured to: carry out a signaling interaction with the UE through the application server, establish a media channel with the UE; interact with the WEB server, load the WEB page on a WEB browser according to the service request of the UE; capture data of the WEB page on the WEB browser, sends the data after encapsulation to the UE through the media channel; receive key information sent from the UE through the media channel, and send the key information of the UE to the WEB browser in manner of a windows message, so as to realize an operation on the WEB page; and
the WEB server is configured to provide the WEB page corresponding to the service requested by the user;
wherein, the service development platform comprises a control module and a WEB browser process module, wherein,
the control module is configured to: establish a media channel with a user equipment (UE) which initiates a service request; and
the WEB browser process module is configured to: load a WEB page on a WEB browser according to the service request of the UE; capture data of the WEB page on the WEB browser, and sends the captured data of the WEB page after encapsulation to the UE through the media channel established by the control module; and receive key information of the UE through the media channel, and send the key information to the UE to the WEB browser in manner of a windows message, so as to realize an operation on the WEB page.
